(19) United States
(12) Patent Application Publication
(10) Pub. No.: US 2004/0160419 A1
(43) Pub. Date: Aug. 19, 2004

(54) Method for entering alphanumeric characters into a graphical user interface

(75) Inventor: David Gary Padgitt, Schaumburg, IL (US)

Correspondence Address: Howard E. Silverman, Greenberg Traurig, 77 West Wacker Drive, Ste. 2500, Chicago, IL, 60601, US

(73) Assignee: Terradigital Systems LLC.

(21) Appl. No.: 10/364,130

(22) Filed: Feb. 11, 2003

(51) Int. Cl. G09G 5/00

(52) U.S. Cl. 345/173

(57) ABSTRACT

A method for entering alphanumeric data into an user interface associated with an electronic device. The user interface displays a plurality of alphanumerical characters and, in response to user input that functions to target one of the plurality of alphanumerical characters, the user interface displays the targeted alphanumeric character with a highlighted feature that distinguishes the targeted alphanumeric character from the non-targeted alphanumeric characters.

### BACKGROUND OF THE INVENTION

This invention relates generally to electronic devices and, more particularly, relates to a method for entering alphanumeric characters into the graphical user interface of an electronic device.

Graphical user interfaces are increasing found in electronic devices and have gained wide popularity due to their capacity to make operation of an electronic device much more user friendly. Virtually every personal computer in use today incorporates a graphical user interface typically using icons which correspond to commands which can be selected using a pointer manipulated by a mouse. Graphical user interfaces are even used to provide the user with ability to enter data into an electronic device. One such example well known in the art relies upon a touch screen display which presents alphanumeric buttons or keys to the user which can be selected, much like typing on a keyboard, toward entering alphanumeric data. However, such well known graphical user interfaces are not typically capable of being used for alphanumeric data entry in connection with a device having a touch screen display of limited size, i.e., where the touch screen display is not of sufficient size to allow the graphical user interface elements to be clearly viewed and/or individually selected. If a touch-screen is significantly smaller than a typical computer keyboard, the displayed alphanumeric buttons or keys are often obscured from the users view by the user's own hand which is attempting to make contact with the surface of the display proximate a particular button or key. In short, the user cannot clearly see which button or key is being pressed thereby frustrating the user experience.

Accordingly, a need exists for an improved graphical user interface that allows a user to clearly discern graphical user interface elements and to interact with those graphical user interface elements even when implemented on an electronic device having a touch screen display of limited size.

### SUMMARY OF THE INVENTION

In order to address this and other needs, described hereinafter is a method for entering alphanumeric characters into the graphical user interface of an electronic device. Generally, the graphical user interface displays a plurality of alphanumerical characters and, in response to user input that functions to target one of the plurality of alphanumerical characters, the user interface displays the targeted alphanumeric character with a highlighted feature that serves to distinguish the targeted alphanumeric character from the displayed, non-targeted alphanumeric characters. By way of example, the targeted alphanumeric character may be provided with a distinct size, font stylization, location, and/or color that serves to distinguishing the targeted alphanumeric character within the graphical user interface display toward confirming to the user the identity of the character being selected.

A better understanding of the objects, advantages, features, properties and relationships of the method will be obtained from the following detailed description and accompanying drawings which set forth illustrative embodiments which are indicative of the various ways in which the principles of the method may be employed.

### BRIEF DESCRIPTION OF THE DRAWINGS

For a better understanding of the method for entering alphanumeric characters into a graphical user interface, reference may be had to preferred embodiments shown in the following drawings in which:

FIG. 1 illustrates a first exemplary graphical user interface by which alphanumeric information may be entered for processing by an electronic device;

FIG. 2 illustrates a further exemplary graphical user interface by which alphanumeric information may be entered for processing by an electronic device;

FIG. 3 illustrates yet another exemplary graphical user interface by which alphanumeric information may be entered for processing by an electronic device; and

FIG. 4 illustrates a still further exemplary graphical user interface by which alphanumeric information may be entered for processing by an electronic device.

### DETAILED DESCRIPTION

Referring now to the figures, wherein like reference numerals refer to like elements, a graphical user interface 10 for use in connection with an electrical device is described. More particularly, the graphical user interface 10 supports a method for entering alphanumeric characters such that the entered alphanumeric characters may be used to cause the electronic device to perform an action, for example, to perform a database search. While the graphical user interface 10 described hereinafter may be used in connection with any microprocessor based electronic device having an associated display, it is particularly suited for use in connection with an electronic device, such as an MP3 player, having a small touch screen display where the displayed graphical user interface elements are typically smaller than a human finger, i.e., a finger touch might overlap multiple target graphical user interface elements. It will be understood that the described graphical user interface may also be useful in a situation where an electronic device fails to include a keyboard or a limited amount of hard entry keys. While the principles of the present invention are disclosed in the context of entering alphanumeric characters into the graphical user interface, the present invention may be used to target and select other indicia for entry into a graphical user interface where such indicia includes not only alphanumeric characters but also symbols and/or graphic elements.

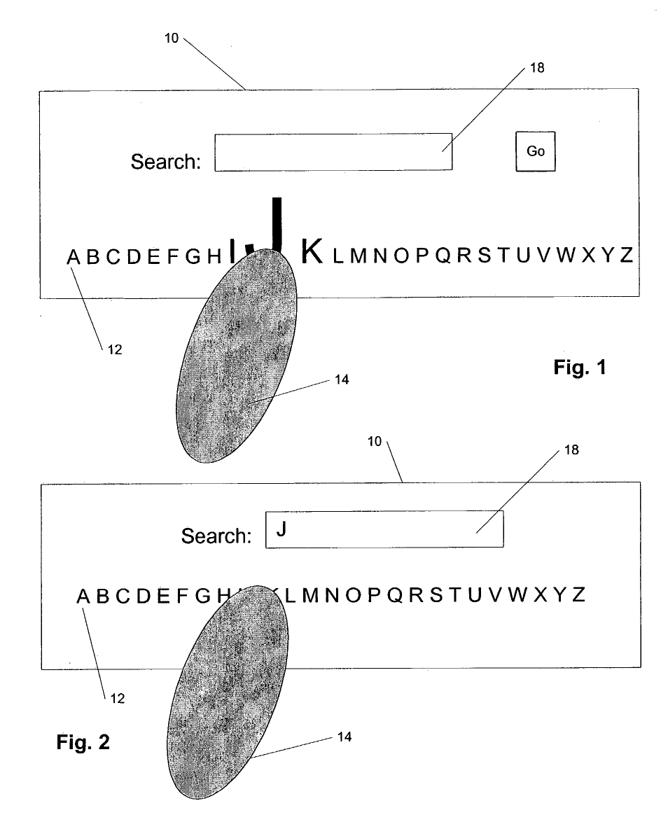

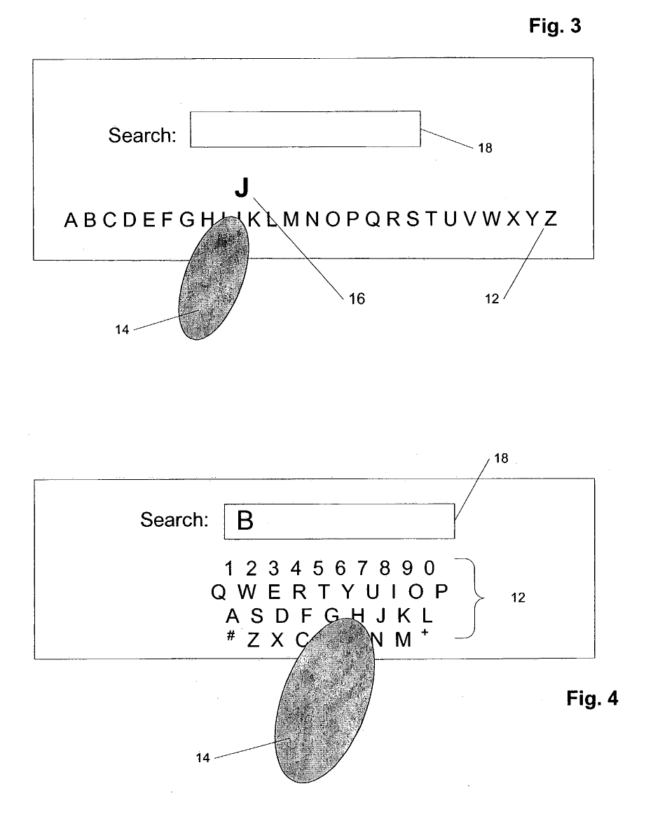

For use in entering alphanumeric character information into the graphical user interface 10, the graphical user interface 10 is adapted to present to the user a plurality of alphanumeric characters 12 that are selectable by the user. As illustrated in FIGS. 1-3, the alphanumeric characters 12 may be presented to the user, for example, using a linear list wherein the alphanumeric characters may be arranged in an alphabetical and/or numerically ascending/descending order. Still further, the alphanumeric characters 12 may be presented to the user using a conventional “QWERTY” or other known keyboard metaphor, as illustrated in FIG. 4. It will also be appreciated that all of the selectable alphanumeric characters 12 need not be displayed at any one time. Rather, the graphical user interface may be adapted to present a subset of the selectable alphanumeric characters 12 provided that a mechanism is available to allow the user to access those alphanumeric characters 12 not currently displayed. Such a mechanism may be provided by using a scroll bar within the graphical user interface, by adapting the touch screen to be responsive to dragging motions, or the like.

For illustrative purposes, the present invention is described in the context of a electronic device which executes a search function, by selecting the “go” button, according to an alphanumeric character string entered by the user. To select one of the displayed alphanumeric characters 12 for entry into the device, for example, to be ultimately used in the performance of a search executed by an electronic device, the graphical user interface 10 is adapted to be responsive to a pointer 14. For example, when implemented in connection with a touch screen, the graphical user interface 10 will be response to the positioning and/or movements of a pointer 14 such as a stylus or a finger. In the case of a touch screen where the pointer 14 is of a size relative to the selectable alphanumeric characters such that the pointer 14 may overlap multiple alphanumeric characters, the graphical user interface 10 may determine an approximate center location of the pointer 14 and use that location to determine which of the alphanumeric characters 12 is being targeted for selection by the user.

To identify to the user which of the displayed alphanumeric characters 12 is presently being indicated by the graphical user interface as being the target of the pointer 14, the graphical user interface 10 is adapted to highlight the target alphanumeric character. By way of example, the target alphanumeric character may be provided with an appearance that is distinct from the remaining displayed alphanumeric characters, as illustrated in FIG. 1. Such an appearance may be provided through the use of colors, font sizes or stylizations, or the like. Still further, the target character can be highlighted by being presented within a temporary field 18 of the graphical user interface 10 which is a field that is separate and distinct from the displayed alphanumeric characters 12. A size for the highlighted, target alphanumeric character and/or the location for the temporary field 16 are preferably chosen so as to allow the displayed, highlighted, target alphanumeric character to avoid being obscured from the view of a user, for example, by a finger overlaying the alphanumeric characters 12 displayed in a touch screen display, should the system require the user to maintain physical contact with the graphical user interface during the process of identifying target alphanumeric characters.

Once an alphanumeric character has been selected by a user, the user may further indicate that the user desires the target alphanumeric character to be placed into a field of interest, such as the search field 18, used immediately in the performance of an action by an electronic device, or the like. Such user indication may be provided by action of the user breaking physical contact with the surface of the touch screen display. It will also be appreciated that the target alphanumeric character may be highlighted to the user by being displayed directly in an action field, such as search field 18, as illustrated in FIGS. 2 and 4.

To draw the focus of the user to a target alphanumeric character, especially in the case where the target alphanumeric character is not separated from the remaining, non-targeted, displayed alphanumeric characters 12, the graphical user interface 10 may be adapted to change the appearance of certain of the non-targeted alphanumeric characters 12 that are adjacent to or in the proximate vicinity of the target alphanumeric character. Preferably, in this case, the appearance of the alphanumeric characters adjacent to or in the vicinity of the target alphanumeric character is made to be distinct from the remainder of the non-targeted alphanumeric characters as well as the target alphanumeric character. By way of example, FIG. 1 illustrates the alphanumeric characters adjacent to the target alphanumeric “J” as having a font size that is larger than the remaining, non-targeted alphanumeric characters while having a font size that is smaller than the font size that is provided to the target alphanumeric “J.” In this manner, the graphical user interface 10 provides a view of the alphanumeric characters 12 that might be considered to be similar to a view seen through a magnifying glass with the target alphanumeric character as the point of focus. It may again be preferable to select font sizes that allow any highlighted alphanumeric characters to be visible should the system require the user to maintain contact with the graphical user interface during the process of identifying target alphanumeric characters. It may also be desirable to adapt the graphical user interface such that each of the alphanumeric characters that a pointer 14 overlays is highlighted to some degree.

For allowing a user to select a target alphanumeric character as being of interest in the further performance of an action by the electronic device, the user may perform an action as simple as removing the pointer 14 from the graphical user interface 10. The selection of a target alphanumeric character may also involve a two step process, namely, requiring the user to remove the pointer 14 from the graphical user interface 10 and then requiring the user to retouch some portion of the pointer 14 to the graphical user interface, preferably at a designated location that would not be confused with a desire to change which of the alphanumeric characters 12 is intended to be the target. In such a two step process, since the pointer 14 would be removed from the graphical user interface, it is preferred to continue to highlight for the user the alphanumeric character that was last targeted by the user as being of interest. In either process, it may also be desirable to adapt the graphical user interface 10 such that alphanumeric characters are highlighted in an order that follows the pointer is it may be dragged or moved along the displayed alphanumeric characters 12. Furthermore, once the user indicates a desire to use the targeted alphanumeric character (or not use the targeted alphanumeric character either by affirmative action, a time-out, or the like) it may be desired to return the graphical user interface 10 to its initial state where no alphanumeric characters are highlighted.

While specific embodiments of the invention have been described in detail, it will be appreciated by those skilled in the art that various modifications and alternatives to those details could be developed in light of the overall teachings of the disclosure. Accordingly, the particular arrangement disclosed is meant to be illustrative only and not limiting as to the scope of the invention which is to be given the full breadth of the appended claims and any equivalents thereof.

What is claimed is:

1. A method for entering alphanumeric data into an user interface associated with an electronic device, the method comprising:
displaying with the user interface a plurality of alphanumerical characters having a first size;
accepting user input via the touch screen that functions to target one of the plurality of alphanumerical characters; and
displaying the targeted alphanumeric character with a second size where the second size is larger that the first size.

2. The method according to claim 1 further comprising targeting only one of the plurality of alphanumeric characters when the user input comprises a physical contact with the touch screen that overlays a plurality of the alphanumeric characters.

3. The method according to claim 2 wherein the alphanumeric characters are initially displayed on the touch screen display smaller than a tip of a typical human finger such that touching the display screen would otherwise overlie and thus identify a plurality of the alphanumeric characters.

4. The method according to claim 1 wherein the first size is selected to permit simultaneous viewing of all of the alphanumeric characters.

5. The method according to claim 1 wherein the second size is selected to allow the targeted alphanumeric character to be at least partially viewable under a pointer used to provide user input via the touch screen.

6. The method according to claim 1 further including the step of displaying the targeted alphanumeric character in a color that differs from the color of non-targeted alphanumeric characters.

7. The method according to claim 1 further comprising accepting user input to select the targeted alphanumeric character for use in connection with an operation to be performed by the electronic device.

8. The method according to claim 7 wherein the operation comprises a database search.

9. The method according to claim 7 wherein the user input to select the targeted alphanumeric character comprises a removal of a pointer from the touch screen display.

10. The method according to claim 7 wherein the user input to select the targeted alphanumeric character comprises an additional touching of a pointer to the touch screen display.

11. The method according to claim 1 further comprising displaying alphanumeric characters adjacent to the targeted alphanumeric character with a third size that is larger that the first size and smaller than the second size.

12. The method according to claim 1 further comprising displaying the alphanumeric characters using a QWERTY keyboard metaphor.

13. A method for providing a user with the ability to enter data into an electronic device having a touch screen display displaying a graphical user interface and permitting the user to control the operation of the electronic device via the graphical user interface by making physical contact with the touch screen, the method comprising:
displaying a plurality of alphanumeric characters on the graphical user interface; and
displaying in a graphical user interface field that is spatially removed from the alphanumeric characters one of the alphanumeric characters determined to be a target of the physical contact with the touch screen display when the physical contact on the touch screen display overlays a plurality of the alphanumeric characters.

14. The method according to claim 13 wherein the alphanumeric characters are initially displayed on the touch screen display smaller than a tip of a typical human finger such that touching the display screen would otherwise overlie and thus identify a plurality of the alphanumeric characters.

15. The method according to claim 13 wherein the alphanumeric characters are displayed using a size selected to permit simultaneous viewing of all of the alphanumeric characters within the touch screen display.

16. The method according to claim 13 further comprising accepting user input to select the targeted alphanumeric character for use in connection with an operation to be performed by the electronic device.

17. The method according to claim 16 wherein the field in which the targeted alphanumeric character is displayed is used in connection with the operation to be performed by the electronic device.

18. The method according to claim 17 wherein the operation comprises a database search.

19. The method according to claim 16 wherein the user input to select the targeted alphanumeric character comprises a removal of the physical contact from the touch screen display.

20. The method according to claim 16 wherein the user input to select the targeted alphanumeric character comprises an additional physical contact with the touch screen display.

21. A method for selecting alphanumeric characters to be entered into an electronic device having a touch screen display which provides a user with an ability to control the operation of the electronic device by physically contacting the touch screen display, the method comprising:
displaying the alphanumeric characters on the touch screen display;
displaying all of the characters in a first size when no physical contact is made with the touch screen display; and
displaying a one of the alphanumeric characters determined to be a target of physical contact with the touch screen display in a second size.

22. The method according to claim 21 further comprising entering the targeted alphanumeric character into the electronic device to cause the electronic device to perform an action when the physical contact is removed from the touch screen display.

23. The method according to claim 21 further comprising displaying alphanumeric characters adjacent to the targeted alphanumeric character with a third size that is larger than the first size and smaller than the second size.

24. The method according to claim 21 further comprising displaying the targeted alphanumeric character in a color that differs from a color of adjacently displayed alphanumeric characters.

25. The method according to claim 21 wherein the targeted alphanumeric character returns to the first size after being entered.

26. The method according to claim 21 wherein the alphanumeric characters are displayed in a line.

27. The method according to claim 21 wherein the alphanumeric characters are displayed in alphabetical order.

28. A method for entering data into an user interface associated with an electronic device, the method comprising:
displaying with the user interface a plurality of indicia having a first size;
accepting user input via the touch screen that functions to target one of the plurality of indicia; and
displaying the targeted indicia with a second size where the second size is larger that the first size.

29. The method according to claim 28 wherein the indicia comprise alphanumeric characters, symbols and graphic elements.
